(19) United States
(12) Patent Application Publication
(10) Pub. No.: US 2019/0050966 A1
(43) Pub. Date: Feb. 14, 2019

(54) METHOD AND APPARATUS FOR DETECTING NOISE OF SATELLITE IMAGE AND RESTORING IMAGE

(71) Applicant: Electronics and Telecommunications Research Institute, Daejeon (KR)

(72) Inventors: Tae Jung Kim, Daejeon (KR); Do-Seob Ahn, Daejeon (KR); Ilgu Jung, Daejeon (KR)

(73) Assignee: Electronics and Telecommunications Research Institute, Daejeon (KR)

(21) Appl. No.: 15/830,885

(22) Filed: Dec. 4, 2017

(30) Foreign Application Priority Data
Aug. 9, 2017 (KR) 10-2017-0101004

(51) Int. Cl. G06T 5/00; G06T 7/246

(52) U.S. Cl. CPC G06T 5/002; G06T 2207/10036; G06T 7/248

(57) ABSTRACT

A method of restoring an image is disclosed. The method may include obtaining multispectral images of an identical object using a plurality of different channels, identifying a noise image including a noise among the multispectral images, determining reference images to be used to restore the noise image among the multispectral images, detecting a noise area of the noise image based on a relationship between the noise image and the reference images, and restoring the detected noise area using pixels of the reference images.

### CROSS-REFERENCE TO RELATED APPLICATION(S)

This application claims the priority benefit of Korean Patent Application No. 10-2017-0101004 filed on Aug. 9, 2017, in the Korean Intellectual Property Office, the disclosure of which is incorporated herein by reference for all purposes.

### BACKGROUND

### 1. Field

One or more example embodiments relate to a method of restoring a satellite image in which a noise occurs, and more particularly, to a method of restoring an image in which a noise occurs using a satellite image obtained through a plurality of channels having different wavelengths.

### 2. Description of Related Art

Due to the development of information technology (IT), news, newspapers, weather information, and satellite data may be viewed and used in real time, anywhere, and at any time, through the Internet or smartphones. A weather image and a satellite image may be used not only in public institutions and in connection with various IT industry fields but also for general users in a service form, for example, a map and a weather forecast. However, image data received from a satellite may cause noise in an image for various reasons, for example, a condition of an environment of the observation area and cloud movement.

Thus, a method of effectively removing noise occurring in an image has been requested that would make it possible to provide a high-quality satellite image for a user or to provide a more accurate weather prediction.

### SUMMARY

An aspect provides a method and apparatus for detecting a noise area of a satellite image in which a noise occurs using a plurality of satellite images obtained through a plurality of channels using different wavelengths at different points in time.

Another aspect also provides a method and apparatus of restoring a noise area of a satellite image in which a noise occurs using a plurality of satellite images obtained through a plurality of channels using different wavelengths at different points in time.

According to an aspect, there is provided a method of restoring an image including obtaining multispectral images of an identical object using a plurality of different channels, identifying a noise image including a noise among the multispectral images, determining reference images to be used to restore the noise image among the multispectral images, detecting a noise area of the noise image based on a relationship between the noise image and the reference images, and restoring the detected noise area using pixels of the reference images.

The determining of the reference images may include determining the reference images based on an amount of time used to obtain the noise image and a channel of the noise image.

The detecting of the noise area may include detecting the noise area from the noise image based on (i) a relationship between the noise image and a first reference image obtained using a channel differing from that of the noise image, and (ii) a relationship between a second reference image obtained at a point in time differing from a point in time at which the noise image is obtained and a third reference image obtained using a channel differing from that of the noise image and at the point in time differing from the point in time at which the noise image is obtained.

The first reference image and the third reference image may be obtained at different points in time using an identical channel, and the second reference image and the third reference image are obtained at an identical point in time.

The restoring of the noise area may include determining a pixel value of an estimation pixel using the reference images, determining a reference pixel corresponding to the noise area in the first reference image, and restoring the noise area using the pixel value of the estimation pixel and a pixel value of the reference pixel.

The determining of the pixel value of the estimation pixel may include determining a movement vector using a movement between pixels at identical positions of the first reference image and the third reference image, and determining the pixel value of the estimation pixel using the second reference image, the third reference image, and the movement vector.

According to another aspect, there is provided an image restoring apparatus including a processor, wherein the processor is configured to obtain multispectral images of an identical object using a plurality of different channels, identify a noise image including a noise among the multispectral images, determine reference images to be used to restore the noise image among the multispectral images, detect a noise area of the noise image based on a relationship between the noise image and the reference images, and restore the detected noise area using pixels of the reference images.

The processor may be configured to determine the reference images based on a point in time at which the noise image is obtained and a channel of the noise image.

The processor may be configured to detect the noise area from the noise image based on (i) a relationship between the noise image and a first reference image obtained using a channel differing from that of the noise image, and (ii) a relationship between a second reference image obtained at a point in time differing from a point in time at which the noise image is obtained and a third reference image obtained using a channel differing from that of the noise image and at the point in time differing from the point in time at which the noise image is obtained.

The first reference image and the third reference image may be obtained at different points in time using an identical channel, and the second reference image and the third reference image are obtained at an identical point in time.

The processor may be configured to determine a pixel value of an estimation pixel using the reference images, determine a reference pixel corresponding to the noise area in the first reference image, and restore the noise area using the pixel value of the estimation pixel and a pixel value of the reference pixel.

The processor may be configured to determine a movement vector using a movement between pixels at identical positions of the first reference image and the third reference image, and determine the pixel value of the estimation pixel using the second reference image, the third reference image, and the movement vector.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an apparatus for restoring a noise image among images received from a satellite according to an example embodiment;

FIG. 2 illustrates images received from a satellite based on points in time and channels according to an example embodiment;

FIG. 3 is a flowchart illustrating a method of restoring an image according to an example embodiment;

FIG. 4 is a flowchart illustrating a method of restoring a noise area according to an example embodiment;

FIG. 5 illustrates a noise image and a reference image according to an example embodiment; and

FIG. 6 illustrates a method of determining a movement vector according to an example embodiment.

### DETAILED DESCRIPTION

Hereinafter, some example embodiments will be described in detail with reference to the accompanying drawings.

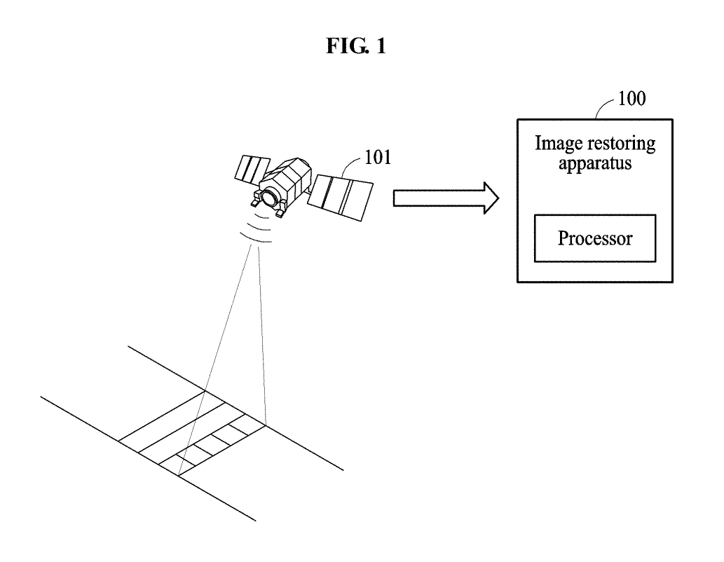

FIG. 1 illustrates an apparatus for restoring a noise image among images received from a satellite according to an example embodiment.

A satellite 101 may obtain multispectral images of an identical object using a plurality of different channels. The different channels may use a plurality of different wavelengths to obtain an image of the object.

An image restoring apparatus 100 may receive the multispectral images of the identical object obtained by the satellite 101 using the different channels. In addition, a processor of the image restoring apparatus 100 may identify a noise image among the multispectral images received from the satellite 101 and detect a noise area from the identified noise image. Also, the processor may restore the detected noise image.

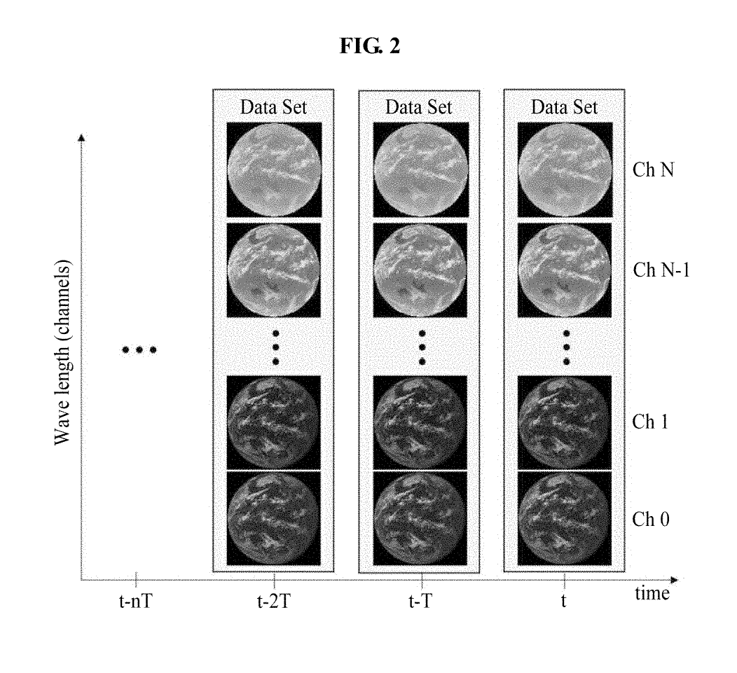

FIG. 2 illustrates images received from a satellite based on points in time and channels according to an example embodiment.

Referring to FIG. 2, the satellite 101 may obtain multispectral images of an identical object at a point in time t using a plurality of different channels (Ch 0 through Ch N) using different wavelengths.

A processor of the image restoring apparatus 100 may identify a noise image including a noise among the multispectral images captured by the satellite 101. In addition, a noise area of the noise image may be detected and the noise image may be restored based on a point in time at which the noise image is obtained and a channel used to obtain the noise image.

For example, in response to the noise image being obtained using a channel Ch 1 at the point in time t, the processor restores the noise image by detecting the noise area of the noise image using a reference image obtained using a channel differing from the channel Ch 1 at the point in time t, a reference image obtained using the channel Ch 1 at a point in time differing from the point in time t, and a reference image obtained using a channel differing from the channel Ch 1 at the point in time differing from the point in time t.

Hereinafter, a channel used to obtain the noise image is referred to as a noise channel, and a channel differing from the noise channel among channels used to obtain reference images is referred to as a reference channel.

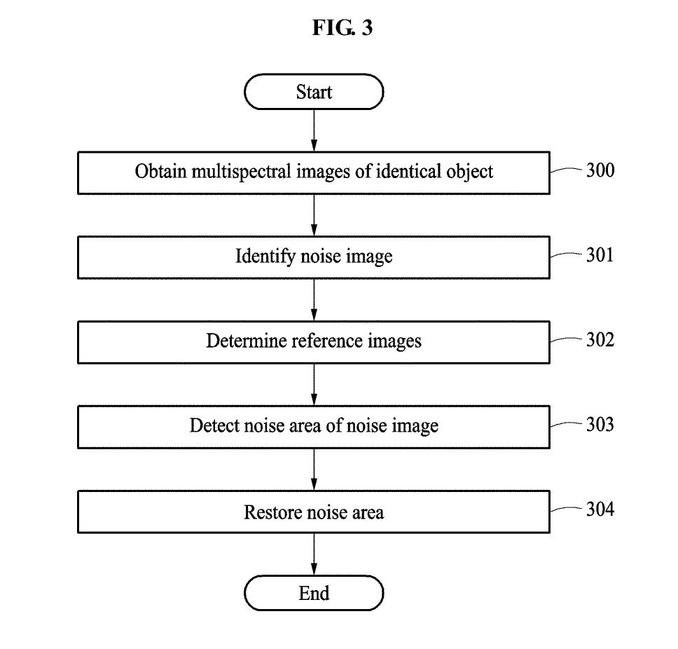

FIG. 3 is a flowchart illustrating a method of restoring an image according to an example embodiment.

In operation 300, a processor of the image restoring apparatus 100 obtains multispectral images of an identical object obtained by the satellite 101 using a plurality of different channels using different wavelengths.

In operation 301, the processor of the image restoring apparatus 100 identifies a noise image including a noise among the multispectral images obtained from the satellite 101.

In operation 302, the processor of the image restoring apparatus 100 detects the noise area of the noise image and determines reference images for restoring the noise image based on a channel used to obtain the noise image and a point in time at which the noise image is obtained.

In more detail, the processor may determine, as reference images, an image obtained at a point in time identical to the point in time at which the noise image is obtained using a reference channel, an image obtained at a point in time differing from the point in time at which the noise image is obtained using the noise channel, and an image obtained at the point in time differing from the point in time at which the noise image is obtained using the reference channel, among the multispectral images.

Here, the reference channel differs from the noise channel. Based on a result of testing a similarity between the noise image and images obtained using neighboring channels of the noise channel, the reference channel may be used to obtain an image having a greatest similarity with the noise image.

As an example of a similarity test, the processor may perform the similarity test by calculating a mean square error (MSE) between the noise image and the multispectral images obtained using the neighboring channels of the noise channel as expressed in Equation 1.

$$Reff ( x , y ) = {min arg}_{f ∈ Neighbor WV} \{ MSE \vert {I}_{noise - CH}^{t} ( x , y , NIf ( x , y ) ] \} \qquad [ Equation 1 ]$$

In Equation 1, Ref^{t} denotes a pixel value of a noise image obtained at a point in time t using a reference channel, and I^{t} denotes a pixel value of a noise image obtained at the point in time t using a noise channel. Also, NI^{t} denotes a pixel value of an image obtained at the point in time t using neighboring channels of the noise channel. In addition, x and y denote values indicating a position of a pixel in an image.

The processor may calculate the MSE between the noise image and the multispectral images obtained using the neighboring channels of the noise channel, and determine an image having a minimum MSE as a reference image having a greatest similarity with the noise image. The processor may determine the channel used to obtain the reference image having the minimum MSE as the reference channel. However, the similarity test using the MSE is only an example. The similarity test is not limited thereto.

In operation 303, the processor of the image restoring apparatus 100 detects the noise area of the noise image based on a relationship between the noise image and the determined reference images.

In more detail, the processor may determine a difference by comparing a reference image obtained at a point in time differing from the point in time at which the noise image is obtained using the noise channel to a reference image obtained at the point in time differing from the point in time at which the noise image is obtained using the reference channel. The processor may detect the noise area of the noise image by comparing the determined difference to a difference between the noise image and a reference image obtained at a point in time identical to the point in time at which the noise image is obtained using the reference channel.

In operation 304, the processor of the image restoring apparatus 100 restores the noise area of the noise image using pixels of the determined reference images.

In more detail, the processor may determine a movement vector by comparing pixel movements of the reference images obtained using the reference channel. The processor may determine an estimation pixel using the determined movement vector and the reference images obtained at the point in time differing from the point in time at which the noise image is obtained. In addition, the processor may restore the noise area of the noise image using a pixel value of the determined estimation value and a pixel value of a reference pixel of the reference image obtained at the point in time identical to the point in time at which the noise image is obtained.

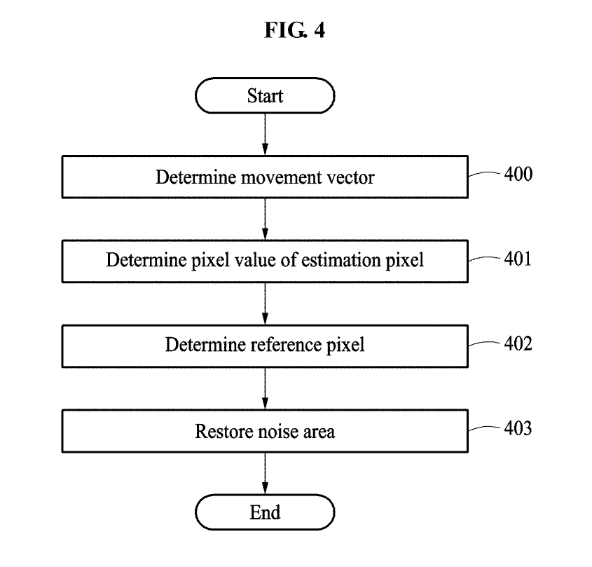

FIG. 4 is a flowchart illustrating a method of restoring a noise area according to an example embodiment.

In operation 400, a processor of the image restoring apparatus 100 determines a movement vector using reference images obtained using a reference channel.

In more detail, the processor may determine a movement vector associated with a best matching point (BMP) obtained by searching for a movement between pixels associated with identical positions of a reference image obtained at a point in time identical to a point in time at which the noise image is obtained using the reference channel and a reference image obtained at a point in time differing from the point in time at which the noise image is obtained using the reference channel.

In operation 401, the processor of the image restoring apparatus determines a pixel value of an estimation pixel using the movement vector and the reference images obtained at the point in time differing from the point in time at which the noise image is obtained using a noise channel.

In more detail, the processor may determine the pixel value of the estimation value using a pixel value obtained by applying the movement vector to the reference image obtained at the point in time differing from the point in time at which the noise image is obtained using the noise channel and a pixel value obtained by applying the movement vector to the reference image obtained at the point in time differing from the point in time at which the noise image is obtained using the reference channel.

In operation 402, the processor of the image obtaining apparatus 100 determines, as a reference pixel, a pixel corresponding to the noise area in the noise image from the reference image obtained at the point in time differing from the point in time at which the noise image is obtained using the reference channel.

In operation 403, the processor of the image obtaining apparatus 100 restores the noise area by adding the determined pixel value of the estimation pixel to a pixel value of the determined reference pixel.

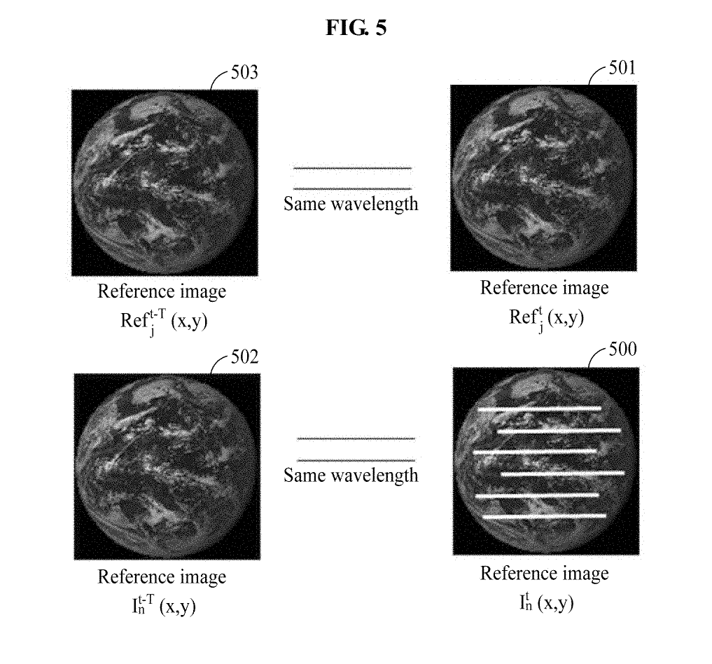

FIG. 5 illustrates a noise image and a reference image according to an example embodiment.

A noise image 500 is obtained by the satellite 101 at a point in time t using a noise channel. A reference image 501 is obtained by the satellite 101 at the point in time t using a reference channel, and a reference image 502 is obtained by the satellite 101 at a point in time t−T using the noise channel. Also, a reference image 503 is obtained by the satellite 101 at the point in time t−T using the reference channel.

A processor of the image restoring apparatus 100 sets a threshold value for detecting a noise area of the noise image 500 using the reference images 502 and 503. In more detail, the processor may calculate a maximum value and a minimum value of absolute values with respect to a difference between a pixel of the reference image 502 and a pixel of the reference image 503 using Equation 2.

[Min.Max]=|Iₙ^{t-T}(x,y)−Refⱼ^{t-T}(x,y)| [Equation 2]

In Equation 2, I^{t-T}denotes a pixel value of the reference image 502, and Ref^{t-T} denotes a pixel value of the reference image 503.

In addition, the processor may set the threshold value for detecting the noise area using the maximum value and the minimum value of the absolute values with respect to the difference between the pixel of the reference image 502 and the pixel of the reference image 503 and Equation 3.

$$th = \frac{Max - Mean}{2} \qquad [ Equation 3 ]$$

In Equation 3, th denotes a threshold value for detecting the noise area and Max denotes a maximum value of absolute values with respect to .the difference between the pixel of the reference image 502 and the pixel of the reference image 503. Also, Mean denotes an average value of the absolute values with respect to the difference between the pixel of the reference image 502 and the pixel of the reference image 503. Here, the threshold value set using Equation 3 is only an example. A method of setting the threshold value is not limited thereto.

The processor of the image restoring apparatus 100 may detect the noise area of the noise image 500 using the noise image 500, the reference image 501, and the set threshold value.

In more detail, the processor may detect the noise area of the noise image. 500 using Equation 4.

NoiseArea(x,y)=Iₙ^{t}(x, y)=Refⱼ^{t}(x,y) [Equation 4]

In Equation 4, I^{t} denotes a pixel value of the noise image 500 and Ref^{t} denotes a pixel value of the reference image 501. The processor may calculate a difference value between the pixel value of the noise image 500 and the pixel value of the reference image 501, and determine, as the noise area, an area of which the calculated difference value is greater than the threshold value using the reference images 502 and 503.

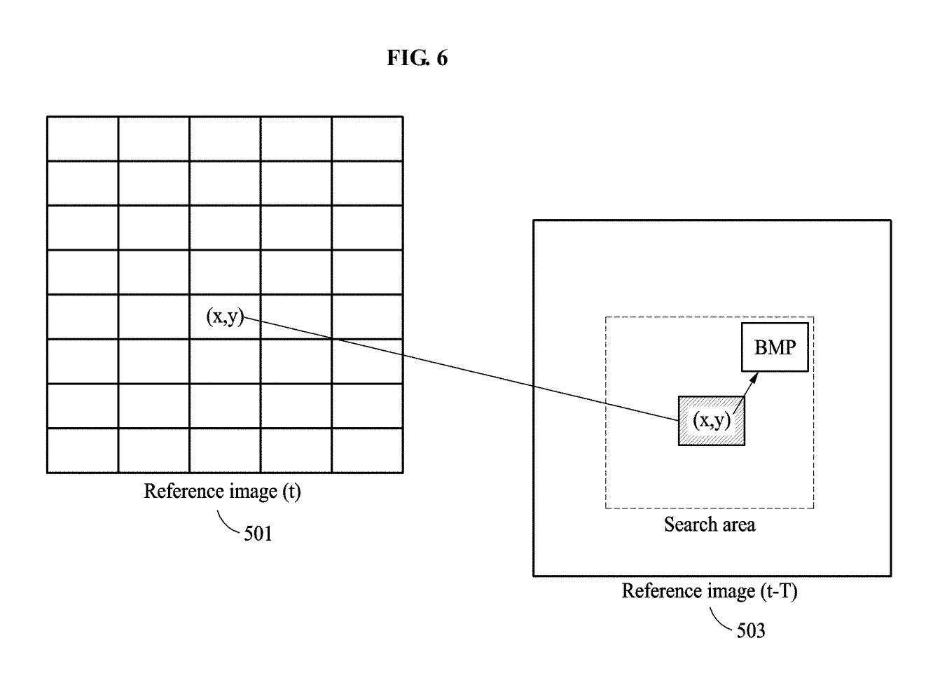

FIG. 6 illustrates a method of determining a movement vector according to an example embodiment.

A processor of the image restoring apparatus 100 may restore a noise area detected from the noise image 500 using pixels of the reference images 501 through 503.

The processor may determine a movement vector with respect to a best matching point (BMP) determined by searching for a movement between a pixel of the reference image 501 obtained at a point in time t using a reference image and a pixel of the reference image 503 obtained at a point in time t−T using the reference channel.

In more detail, the processor may determine the movement vector by calculating a is position at which a difference between the reference image 501 and the reference image 503 is smallest within a search area using Equation 5.

BMP(dx,xy)=min {[Refⱼ^{t}(x,y)−Refⱼ^{t-T}(x+dx,y+dy)]²} [Equation 5]

In Equation 5, dx and dy are associated with a movement vector.

Also, the processor may determine a pixel value of an estimation pixel to be used to restore the noise area using the determined movement vector and the reference images 502 and 503.

In more detail, the processor may determine the pixel value of the estimation pixel using Equation 6.

b=Iₙ^{t-T}(x|dx,x|dy)Refⱼ^{t-T}(x|dx,x|dy) [Equation 6]

In Equation 6, b denotes the pixel value of the estimation pixel. Lastly, the processor may determine a reference pixel corresponding to the noise area of the noise image 500 from the reference image 501 and restore the noise area of the noise image 500 using Equation 7.

Restored_Iₙ^{t}(x,y)≅Refₙ^{t}(x,y)+b [Equation 7]

In Equation 7, Ref^{t} denotes the pixel value of the reference pixel and b denotes the pixel value of the estimation pixel. Also, Restored_I^{t} denotes the pixel value of the restored noise image.

The components described in the exemplary embodiments of the present invention may be achieved by hardware components including at least one Digital Signal Processor (DSP), a processor, a controller, an Application Specific Integrated Circuit (ASIC), a programmable logic element such as a Field Programmable Gate Array (FPGA), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of restoring an image, the method comprising:
obtaining multispectral images of an identical object using a plurality of different channels;
identifying a noise image including a noise among the multispectral images;
determining reference images to be used to restore the noise image among the multispectral images;
detecting a noise area of the noise image based on a relationship between the noise image and the reference images; and
restoring the detected noise area using pixels of the reference images.

2. The method of claim 1, wherein the determining of the reference images comprises determining the reference images based on an amount of time used to obtain the noise image and a channel of the noise image.

3. The method of claim I, wherein the detecting of the noise area comprises detecting the noise area from the noise image based on (i) a relationship between the noise image and a first reference image obtained using a channel differing from that of the noise image, and (ii) a relationship between a second reference image obtained at a point in time differing from a point in time at which the noise image is obtained and a third reference image obtained using a channel differing from that of the noise image and at the point in time differing from the point in time at which the noise image is obtained.

4. The method of claim 3, wherein the first reference image and the third reference image are obtained at different points in time using an identical channel, and the second reference image and the third reference image are obtained at an identical point in time.

5. The method of claim 3, wherein the restoring of the noise area comprises:
determining a pixel value of an estimation pixel using the reference images;
determining a reference pixel corresponding to the noise area in the first reference image; and
restoring the noise area using the pixel value of the estimation pixel and a pixel value of the reference pixel.

6. The method of claim 5, wherein the determining of the pixel value of the estimation pixel comprises:
determining a movement vector using a movement between pixels at identical positions of the first reference image and the third reference image; and
determining the pixel value of the estimation pixel using the second reference image, the third reference image, and the movement vector.

7. An image restoring apparatus, comprising:
a processor,
wherein the processor is configured to obtain multispectral images of an identical object using a plurality of different channels, identify a noise image including a noise among the multispectral images, determine reference images to be used to restore the noise image among the multispectral images, detect a noise area of the noise image based on a relationship between the noise image and the reference images, and restore the detected noise area using pixels of the reference images.

8. The image restoring apparatus of claim 7, wherein the processor is configured to determine the reference images based on a point in time at which the noise image is obtained and a channel of the noise image.

9. The image restoring apparatus of claim 7, wherein the processor is configured to detect the noise area from the noise image based on (i) a relationship between the noise image and a first reference image obtained using a channel differing from that of the noise image, and (ii) a relationship between a second reference image obtained at a point in time differing from a point in time at which the noise image is obtained and a third reference image obtained using a channel differing from that of the noise image and at the point in time differing from the point in time at which the noise image is obtained.

10. The image restoring apparatus of claim 9, wherein the first reference image and the third reference image are obtained at different points in time using an identical channel, and the second reference image and the third reference image are obtained at an identical point in time.

11. The image restoring apparatus of claim 9, wherein the processor is configured to determine a pixel value of an estimation pixel using the reference images, determine a reference pixel corresponding to the noise area in the first reference image, and restore the noise area using the pixel value of the estimation pixel and a pixel value of the reference pixel.

12. The image restoring apparatus of claim 11, wherein the processor is configured to determine a movement vector using a movement between pixels at identical positions of the first reference image and the third reference image, and determine the pixel value of the estimation pixel using the second reference image, the third reference image, and the movement vector.
